(19) United States
(12) Patent Application Publication
(10) Pub. No.: US 2026/0140459 A1
(43) Pub. Date: May 21, 2026

(54) OPTICAL APPARATUS, SCANNING OPTICAL APPARATUS, AND IMAGE FORMING APPARATUS

(71) Applicant: Konica Minolta, Inc., Tokyo (JP)

(72) Inventors: Akira TANIYAMA, Tokyo (JP); Ryo HASEGAWA, Tokyo (JP); Takahiro MATSUO, Tokyo (JP); Yoshihiro INAGAKI, Tokyo (JP); Ema MOCHIZUKI, Tokyo (JP); Tomoki MARUYAMA, Tokyo (JP)

(21) Appl. No.: 19/393,736

(22) Filed: Nov. 19, 2025

(30) Foreign Application Priority Data
Nov. 20, 2024 (JP) 2024-202291

(51) Int. Cl. G03G 15/04; G03G 15/043

(52) U.S. Cl. CPC G03G 15/0409; G03G 15/0435; G03G 2215/0404

(57) ABSTRACT

Provided is an optical apparatus including: a first supporter disposed on one end side of an optical element in a longitudinal direction thereof and supporting a first or second surface thereof; a second supporter disposed on the other end side thereof in the longitudinal direction and supporting a portion of the first surface on one end side of the optical element in a shorter direction thereof; and a third supporter disposed on the other end side thereof in the longitudinal direction and supporting a portion of the first or second surface on the other end side thereof in the shorter direction. A pressing force of a presser pressing the optical element to a side of the second and the third supporter is set to be larger than a pressing force of a first pressing member pressing the optical element to a side of the first supporter.

### CROSS REFERENCE TO RELATED APPLICATIONS

The present invention claims priority under 35 U.S.C. § 119 to Japanese Patent Application No. 2024-202291, filed on Nov. 20, 2024, the entire contents of which being incorporated herein by reference.

### BACKGROUND

### Technological Field

The present invention relates to an optical apparatus, a scanning optical apparatus, and an image forming apparatus.

### Description of Related Art

In an electrophotographic image forming apparatus, an electrostatic latent image is formed on an image carrier such as a photosensitive drum by a scanning optical apparatus, and the electrostatic latent image is developed by a developing apparatus to form a toner image. The scanning optical apparatus forms an electrostatic latent image on an image carrier by polarizing scanning light emitted from a light source with a light polarizer. In the scanning optical apparatus, optical elements such as a mirror and a lens are disposed on an optical path of the scanning light. Various developments have also been made on optical apparatuses including optical elements.

In an optical apparatus, one end side of an optical element in the longitudinal direction of the optical element may be supported at one point (one location) and the other end side of the optical element in the longitudinal direction of the optical element may be supported at two points (two locations) in order to facilitate the adjustment of the posture of an optical element and to suppress distortion of an optical element (see Japanese Patent Publication Laid-Open No. 2011-100022 or the like). The optical apparatus described in Japanese Patent Publication Laid-Open No. 2011-100022 will be briefly described as follows.

On one end side of the optical element in the longitudinal direction thereof, a first supporter (referred to as a pin in Japanese Patent Publication Laid-Open No. 2011-100022) is disposed which supports, on one side surface of the optical element in the thickness direction thereof, a portion on the center side of the optical element in the shorter direction thereof. On the other end side of the optical element in the longitudinal direction thereof, a second supporter (referred to as a pin in Japanese Patent Publication Laid-Open No. 2011-100022) is disposed which supports a portion of one side surface of the optical element in the thickness direction thereof on one end side of the optical element in the shorter direction thereof. On the other end side of the optical element in the longitudinal direction thereof, a third supporter (referred to as a pin in Japanese Patent Publication Laid-Open No. 2011-100022) is disposed which supports a portion of one side surface of the optical element in the thickness direction thereof on the other end side of the optical element in the shorter direction thereof.

In the optical apparatus described in Japanese Patent Publication Laid-Open No. 2011-100022, the one end side of the optical element in the longitudinal direction thereof is pressed to the side of the first supporter by a first pressing member such as a plate spring. The other end side of the optical element in the longitudinal direction thereof is pressed to the side of the second supporter and the side of the third supporter by a second pressing member such as a plate spring.

Incidentally, in the optical apparatus described in Japanese Patent Publication Laid-Open No. 2011-100022, the pressing location of the first pressing member may be shifted from the location facing the support location of the first supporter due to a machining error or the like, and a rotational moment may act so as to cause the optical element to float from the second supporter or the third supporter. Then, the optical element may rotationally vibrate around an axis along the longitudinal direction thereof to cause degradation of the image quality of the image forming apparatus, such as image density unevenness, for example.

### SUMMARY

An object of the present invention is to provide an optical apparatus and the like capable of suppressing the floating of an optical element from a second supporter and a third supporter in a case where one end side of the optical element in the longitudinal direction thereof is supported at one point and the other end side of the optical element in the longitudinal direction thereof is supported at two points.

In order to achieve at least one of the above-described objects, an optical apparatus reflecting one aspect of the present invention includes:
an optical element that includes a first surface and a second surface on both sides of the optical element, respectively, in a thickness direction of the optical element;
a first supporter that is disposed on one end side of the optical element in a longitudinal direction of the optical element and supports the first surface or the second surface;
a first pressing member that presses the optical element to a side of the first supporter;
a second supporter that is disposed on another end side of the optical element in the longitudinal direction and supports a portion of the first surface on one end side of the optical element in a shorter direction of the optical element;
a third supporter that is disposed on the other end side of the optical element in the longitudinal direction and supports a portion of the first surface or the second surface on another end side of the optical element in the shorter direction; and
a presser that presses the optical element to a side of the second supporter and a side of the third supporter.

A pressing force of the presser is set to be larger than a pressing force of the first pressing member.

A scanning optical apparatus reflecting another aspect of the present invention includes:
a light source that emits scanning light;
a polarizer that polarizes the scanning light emitted from the light source; and
the optical apparatus described above which is disposed on an optical path of the scanning light polarized by the polarizer.

An image forming apparatus reflecting still another aspect of the present invention includes:
an image carrier that forms an image; and
the scanning optical apparatus described above which forms an electrostatic latent image on the image carrier by exposure-scanning the image carrier.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic front view of an image forming apparatus according to the present embodiment;

FIG. 2 is a schematic plan cross-sectional view of a scanning optical apparatus according to the present embodiment;

FIG. 3 is a schematic side cross-sectional view of the scanning optical apparatus according to the present embodiment;

FIG. 4 is a schematic left side view of an optical apparatus according to Embodiment 1;

FIG. 5 is a schematic right side view of the optical apparatus according to Embodiment 1;

FIG. 6 is an enlarged diagram taken along a line VI-VI in FIG. 4;

FIG. 7 is an enlarged diagram taken along a line VII-VII in FIG. 4;

FIG. 8 is a schematic cross-sectional view of one end side of an optical element in the longitudinal direction thereof in the optical apparatus according to another aspect of Embodiment 1;

FIG. 9 is a conceptual diagram of the one end side of the optical element in the longitudinal direction thereof in the optical apparatus according to Embodiment 1;

FIG. 10 is a conceptual diagram of the other end side of the optical element in the longitudinal direction thereof in the optical apparatus according to Embodiment 1;

FIG. 11 is a conceptual diagram of the other end side of the optical element in the longitudinal direction thereof in the optical apparatus according to another aspect of Embodiment 1;

FIG. 12 is a conceptual diagram of the optical element along the longitudinal direction thereof in the optical apparatus according to another aspect of Embodiment 1;

FIG. 13 is a conceptual diagram of one end side of an optical element in the longitudinal direction thereof in an optical apparatus according to Embodiment 2;

FIG. 14 is a conceptual diagram of the other end side of the optical element in the longitudinal direction thereof in the optical apparatus according to Embodiment 2;

FIG. 15 is a conceptual diagram of the other end side of the optical element in the longitudinal direction thereof in an optical apparatus according to a variation of Embodiment 2; and

FIG. 16 is a conceptual diagram of the optical element along the longitudinal direction thereof in the optical apparatus according to the variation of Embodiment 2.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, the present embodiment will be described with reference to the accompanying drawings. Note that, in the specification and claims of the present application, the upstream side refers to the upstream side in the conveyance direction of the sheet, and the downstream side refers to the downstream side in the conveyance direction of the sheet. In the drawings, the “front” indicates the front direction, the “rear” indicates the rear direction, the “left” indicates the left direction, the “right” indicates the right direction, the “up” indicates the up direction, and the “down” indicates the down direction. The “LD” indicates the longitudinal direction of the optical element, the “LDa” indicates one end side of the optical element in the longitudinal direction thereof, and the “LDb” indicates the other end side of the optical element in the longitudinal direction thereof. The “SD” indicates the shorter direction of the optical element, the “SDa” indicates one end side of the optical element in the shorter direction thereof, and the “SDb” indicates the other end side of the optical element in the shorter direction thereof. The “TD” indicates the thickness direction of the optical element, the “TDa” indicates one side of the optical element in the thickness direction thereof, and the “TDb” indicates the other side of the optical element in the thickness direction thereof.

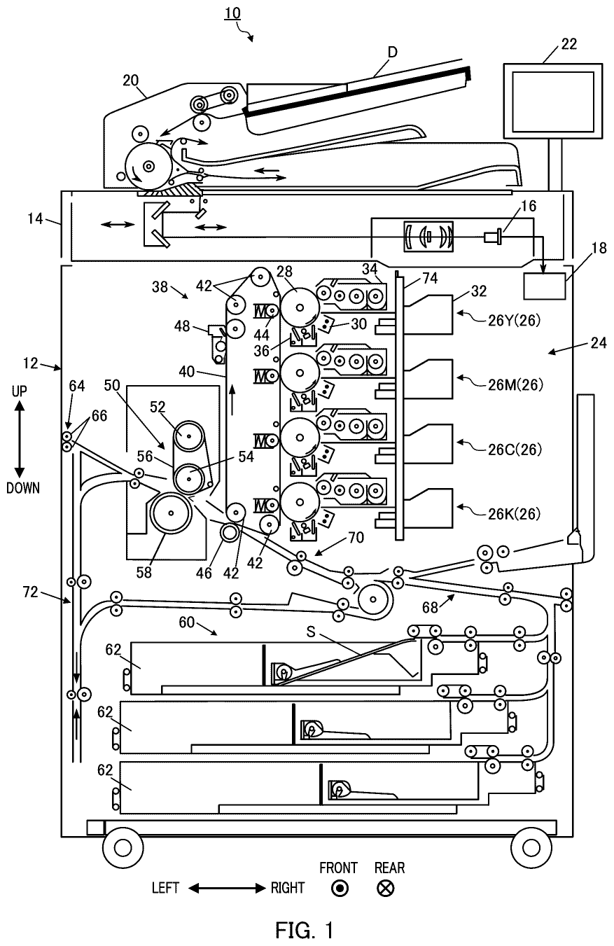

The overall configuration of an image forming apparatus 10 according to the present embodiment will be described with reference to FIG. 1. FIG. 1 is a schematic front view of the image forming apparatus 10 according to the present embodiment.

As illustrated in FIG. 1, the image forming apparatus 10 according to the present embodiment is an apparatus that forms a toner image on a sheet S as a recording medium by an electrophotographic method. The image forming apparatus 10 includes an apparatus main body 12 having a box shape, and the apparatus main body 12 constitutes a base frame of the image forming apparatus 10.

An image reader 14 for reading an image of a document is provided on the top of the apparatus main body 12. The image reader 14 optically scans a document D placed on a contact glass or the document D conveyed onto the contact glass. The image reader 14 optically reads the image of the scanned document with a charge coupled device (CCD) sensor 16 to generate image data. In addition, in an upper portion in the apparatus main body 12, an image processor 18 is provided which performs image processing, such as shading correction and compression processing, on the image data from the image reader 14.

A document conveyor 20 called an auto document feeder (ADF) is provided on the upper side of the image reader 14 at the apparatus main body 12. The document conveyor 20 conveys the document D set in a document tray onto the contact glass of the image reader 14. In addition, an operation display 22 having functions as an operator and a display is provided on a front surface side (front side) above the apparatus main body 12. The operation display 22 is constituted by, for example, a liquid crystal display (LCD) with a touch screen. The operation display 22 includes various types of operation keys such as a numeric keypad and a start key, and receives, as an operator, various types of input operations by the user. The operation display 22 displays, as a display, various types of operation screens, the state of an image, the operating status of each function, and the like.

As illustrated in FIG. 1, an image former 24 that forms an image by an electrophotographic method is provided in the upper portion in the apparatus main body 12. The image former 24 includes four image forming units 26Y, 26M, 26C, and 26K for forming images with respective color toners of yellow (Y), magenta (M), cyan (C), and black (K) components based on image data. The four image forming units 26Y, 26M, 26C, and 26K are arranged along the up-down direction.

The image forming units 26Y 26M, 26C, and 26K for the Y, M, C, and K components have a similar configuration. For convenience of illustration and description, common constituent elements are denoted by the same reference signs, and in a case where common constituent elements are distinguished from each other, Y, M, C, or K is added to the reference signs. In FIG. 1, reference signs are provided only to the constituent elements of the image forming unit 26Y for the Y component and the reference signs for the constituent elements of the other image forming units 26M, 26C, and 26K are omitted.

The image forming unit 26 includes a photosensitive drum 28, and includes an electric charger 30, a scanning optical apparatus (exposer) 32, a developer 34, and a drum cleaner 36 which are disposed around the photosensitive drum 28.

The photosensitive drum 28 is an image carrier for forming an image. The photosensitive drum 28 is, for example, a negatively charged organic photoreceptor in which an undercoat layer, a charge generation layer, and a charge transport layer are sequentially stacked on a peripheral surface of a conductive cylindrical body made of aluminum. The photosensitive drum 28 rotates at a constant circumferential speed by the driving of a rotation motor (not illustrated).

The electric charger 30 uniformly negatively charges the outer peripheral surface of the photosensitive drum 28. The scanning optical apparatus 32 emits laser light as scanning light to scan, while exposing, the outer peripheral surface of the photosensitive drum 28 as an image carrier, thereby forming an electrostatic latent image on the outer peripheral surface of the photosensitive drum 28. The amount of light of the laser light emitted from the scanning optical apparatus 32 is modulated according to image data in each color of YMCK.

The developer 34 is, for example, a developer of a two-component developing method. The developer 34 visualizes the electrostatic latent image on the outer peripheral surface of the photosensitive drum 28 by causing the toner of each of the color components to adhere to the outer peripheral surface of the photosensitive drum 28 to form a toner image. In addition, the drum cleaner 36 cleans transfer residual toner remaining on the outer peripheral surface of the photosensitive drum 28 after the primary transfer. The drum cleaner 36 includes a drum cleaning blade or the like that comes into sliding contact with the outer peripheral surface of the photosensitive drum 28.

As illustrated in FIG. 1, a transferor 38 for transferring a toner image onto the sheet S is provided in the upper portion in the apparatus main body 12. The transferor 38 includes an intermediate transfer belt 40 having an endless shape, a plurality of support rollers 42, a primary transfer roller 44, a secondary transfer roller 46, and a belt cleaner 48.

The intermediate transfer belt 40 extends in the up-down direction and is stretched around the plurality of support rollers 42. The intermediate transfer belt 40 circulates and runs by the rotation of the plurality of support rollers 42. At least one support roller 42 of the plurality of support rollers 42 is constituted by a driving roller coupled to a rotation motor (not illustrated) so as to be interlocked therewith, and the other support rollers 42 are constituted by driven rollers (free rollers).

The primary transfer roller 44 is disposed on the side of the inner peripheral surface of the intermediate transfer belt 40 so as to face the photosensitive drum 28 of each color component. The primary transfer roller 44 cooperates with the photosensitive drum 28 to hold the intermediate transfer belt 40 therebetween. A primary transfer nip CN for transferring the toner image from the photosensitive drum 28 onto the intermediate transfer belt 40 is formed between the outer peripheral surface of the primary transfer roller 44 and the outer peripheral surface of the photosensitive drum 28.

The secondary transfer roller 46 is disposed on the side of the outer peripheral surface of the intermediate transfer belt 40 so as to face a predetermined support roller 42. The secondary transfer roller 46 cooperates with the predetermined support roller 42 to hold the intermediate transfer belt 40 therebetween. A secondary transfer nip TN for transferring the toner image from the intermediate transfer belt 40 onto the sheet S is formed between the outer peripheral surface of the secondary transfer roller 46 and the outer peripheral surface of the predetermined support roller 42.

When the intermediate transfer belt 40 passes through the primary transfer nip CN, the toner images on the photosensitive drum 28 are sequentially primary-transferred onto the intermediate transfer belt 40 in a superimposed manner. Specifically, the toner image is electrostatically transferred onto the intermediate transfer belt 40 by applying primary transfer bias to the primary transfer roller 44, and applying electric charge with a polarity opposite to that of the toner to the side of the rear surface of the intermediate transfer belt 40 (the side on which the intermediate transfer belt 40 abuts on the primary transfer roller 44).

Thereafter, when the sheet S passes through the secondary transfer nip TN, the toner image on the intermediate transfer belt 40 is secondary-transferred onto the sheet S. Specifically, the toner image is electrostatically transferred onto the sheet S by applying secondary transfer bias with the same polarity as that of the toner to the predetermined support roller 42, and applying electric charge with the same polarity as that of the toner to the side of the rear surface of the intermediate transfer belt 40, and an image can be formed on the sheet S.

The belt cleaner 48 removes transfer residual toner remaining on the surface of the intermediate transfer belt 40 after the secondary transfer. The belt cleaner 48 includes a cleaning blade that comes into sliding contact with the surface of the intermediate transfer belt 40.

As illustrated in FIG. 1, a fixer 50 for fixing the toner image onto the sheet S is provided on the side of the exit of the secondary transfer nip TN in the apparatus main body 12. The fixer 50 includes a heating roller 52, a fixing roller 54, a fixing belt 56 having an endless shape, and a pressure roller 58.

The heating roller 52 includes: a hollow cylindrical core metal made of, for example, aluminum, iron, or stainless steel (SUS), or the like; and a heating apparatus, such as a halogen lamp, for example, provided inside the core metal. In addition, the fixing roller 54 is provided at a position facing the heating roller 52. The fixing roller 54 includes: a hollow cylindrical core metal made of, for example, aluminum, iron, SUS, or the like; and a surface layer provided on the outer peripheral surface of the core metal and made of, for example, silicone rubber, silicone sponge, or the like. The fixing belt 56 is stretched around the heating roller 52 and the fixing roller 54, and is rotatable. The fixing belt 56 includes a base material made of, for example, polyimide resin or the like.

The pressure roller 58 is provided at a position facing the fixing roller 54 outside the fixing belt 56, and performs pressing to the side of the fixing roller 54 with a predetermined fixing load. The pressure roller 58 includes: a hollow cylindrical core metal made of, for example, aluminum, iron, SUS, or the like; an elastic layer provided on the outer peripheral surface of the core metal and made of, for example, silicone rubber or the like; and a surface layer provided on the surface of the elastic layer and made of, for example, a PFA tube or the like. In addition, a fixing nip FN for conveying the sheet S while heating and pressurizing the sheet S is formed between the fixing roller 54 and the pressure roller 58.

When the pressure roller 58 rotates by the driving of a rotation motor, the fixing belt 56 is driven to circulate. As the fixing belt 56 circulates, the heating roller 52 and the fixing roller 54 are driven to rotate. Thus, the unarrived toner image can be fixed on the sheet S by conveying the sheet S while heating and pressurizing the sheet S at the fixing nip FN.

As illustrated in FIG. 1, a sheet feeder 60 for feeding the sheet S is provided in a lower portion of the apparatus main body 12. The sheet feeder 60 includes a plurality of sheet feed trays 62 that houses a plurality of sheets S therein. Each sheet feed tray 62 houses sheets S of a type set in advance according to the basis weight, the size, and the like.

On the downstream side of the fixer 50 in the apparatus main body 12, a sheet ejector 64 for ejecting the sheet S, on which an image has already been formed, to the outside of the apparatus main body 12 is provided. The sheet ejector 64 includes a sheet ejection roller pair 66. As the sheet ejection roller pair 66 rotates, the sheet S on which an image has already been formed can be ejected to the outside of the apparatus main body 12.

As illustrated in FIG. 1, a main conveyance path 68 is provided between the sheet feeder 60 and the sheet ejector 64 in the apparatus main body 12. The main conveyance path 68 is a path through the sheet S is conveyed when a toner image is formed on the front surface of the sheet S. The main conveyance path 68 is a path through which the sheet S is conveyed via a plurality of conveyance roller pairs including a registration roller pair 70, the secondary transfer nip TN, and the fixing nip FN. In addition, a reverse conveyance path 72 for reversing the front and rear of the sheet S is provided near the sheet feeder 60 in the apparatus main body 12. The reverse conveyance path 72 is a path through which the sheet S is conveyed when a toner image is formed on the rear surface of the sheet S, and is connected to the main conveyance path 68.

Sheets S housed in the sheet feed tray 62 are fed out one by one starting from the uppermost sheet S and are conveyed toward the secondary transfer nip TN through the main conveyance path 68. At this time, an inclination of the sheet S is corrected by the registration roller pair 70, and a conveyance timing of the sheet S is adjusted. Then, at the secondary transfer nip TN, the toner images on the intermediate transfer belt 40 are secondary-transferred collectively onto one surface (the front surface or the rear surface) of the sheet S, and at the fixing nip FN, the toner images are fixed on the sheet S. Thereafter, the sheet S on which an image has already been formed is ejected to the outside of the apparatus main body 12 from the sheet ejector 64.

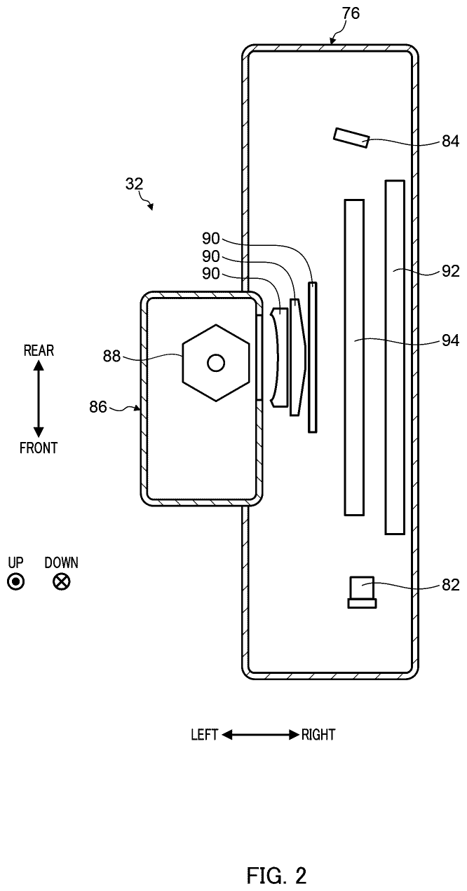

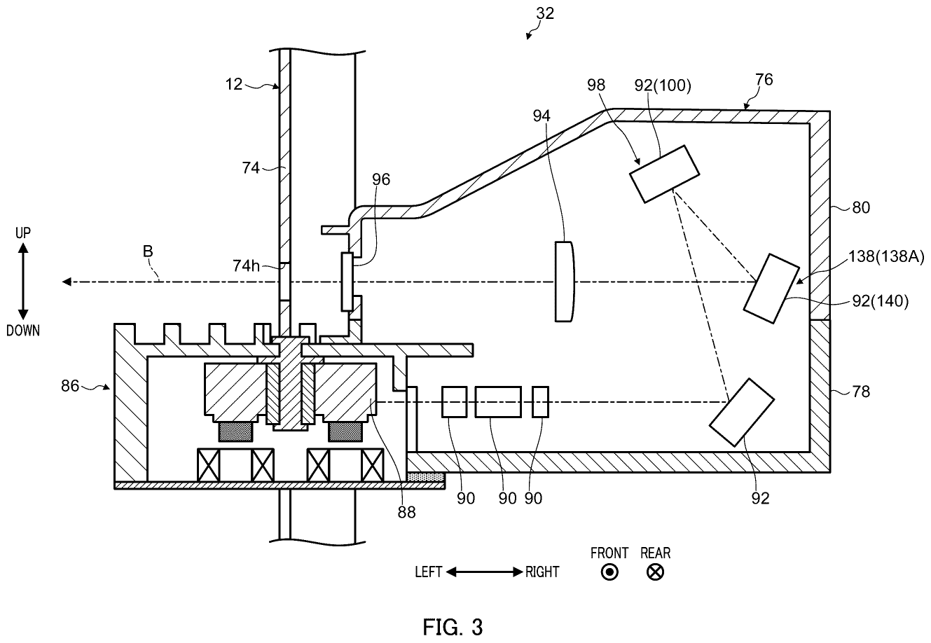

Subsequently, the configuration of the scanning optical apparatus 32 according to the present embodiment will be described with reference to FIG. 2 and FIG. 3. FIG. 2 is a schematic plan cross-sectional view of the scanning optical apparatus 32 according to the present embodiment. FIG. 3 is a schematic side cross-sectional view of the scanning optical apparatus 32 according to the present embodiment.

As illustrated in FIG. 2 and FIG. 3, the scanning optical apparatus 32 includes a housing 76 provided at a partition wall 74 which is a part of the apparatus main body 12, and the housing 76 extends in the front-rear direction. The housing 76 is manufactured by aluminum die-casting. The housing 76 includes a housing main body 78 as an attachment base provided at the partition wall 74, and a cover member 80 detachably provided on the upper side of the housing main body 78.

A light source 82 that emits laser light B as scanning light is provided in the housing 76. On a light emission side of the light source 82 in the housing 76, a collimator lens (not illustrated) is provided which shapes the laser light B of the light source 82 into substantially parallel light. A fold mirror 84 that reflects the laser light B from the light source 82 is provided at a position separated from the light source 82 in the housing 76 in the front-rear direction. Note that, each of the collimator lens and the fold mirror 84 is one of optical elements.

A light polarizer 86 that polarizes the laser light B from the fold mirror 84 is provided to the left of the housing 76. The light polarizer 86 includes a polygon mirror 88 which is rotatable, and the polygon mirror 88 is a so-called rotating polygon mirror. In addition, in the housing 76, a plurality of scanning lenses 90 that converges the laser light B, which has been polarized, from the light polarizer 86 is provided along the optical axis direction. Note that, each of the plurality of scanning lenses 90 is one of optical elements.

In a right portion in the housing 76, a plurality of fold mirrors 92 is provided which reflects the laser light B from the plurality of scanning lenses 90, and each of the fold mirrors 92 extends in the front-rear direction. In addition, at a height position higher than the scanning lenses 90 in the housing 76, a scanning lens 94 is provided which converges the laser light B from the fold mirror 92, and the scanning lens 94 extends in the front-rear direction. In a left side portion of the housing 76, a glass plate 96 for transmitting the laser light B from the scanning lens 94 therethrough is provided. At a position of the partition wall 74, where the position faces the glass plate 96, a through hole 74h for allowing the laser light B to pass therethrough is formed. Note that, each of the plurality of fold mirrors 92 and the scanning lens 94 is one of optical elements.

With the above-described configuration, the laser light B emitted from the light source 82 enters the mirror surface of the polygon mirror 88, which is rotating, via the fold mirror 84. Then, the reflection direction of the laser light B changes according to the rotation angle of the polygon mirror 88, and the laser light B is polarized.

The laser light B that has been polarized is emitted from the scanning lens 94 via the plurality of scanning lenses 90 and the plurality of fold mirrors 92, is transmitted through the glass plate 96, and is emitted from the through hole 74h of the partition wall 74. Then, the laser light B from the through hole 74h of the partition wall 74 is polarized in the main scanning direction while the amount of light of the laser light B is modulated according to image data, and enters the outer peripheral surface of the photosensitive drum 28. Thus, an electrostatic latent image can be formed on the outer peripheral surface of the photosensitive drum 28.

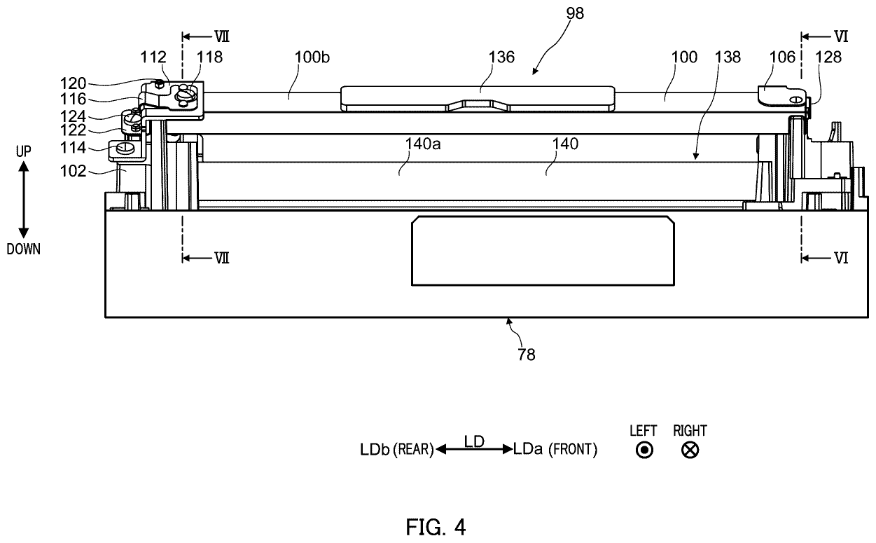

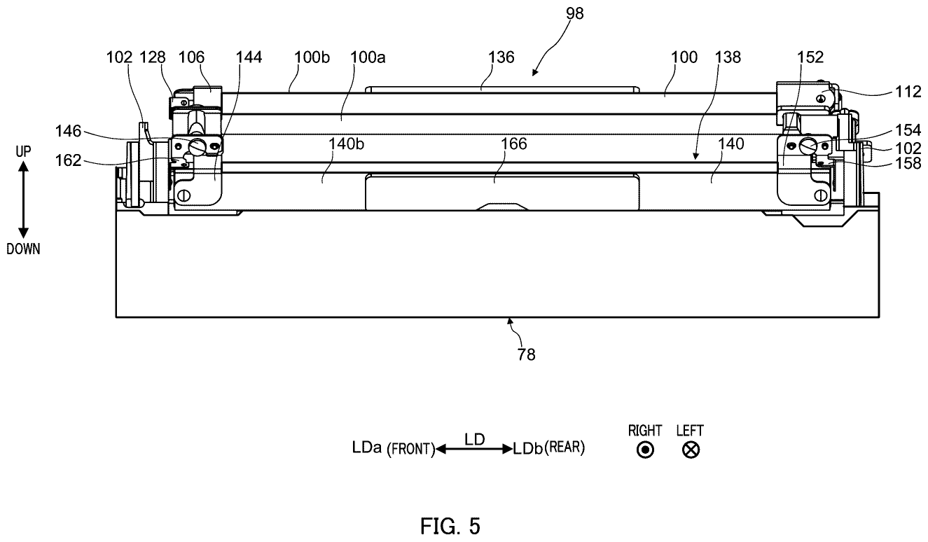

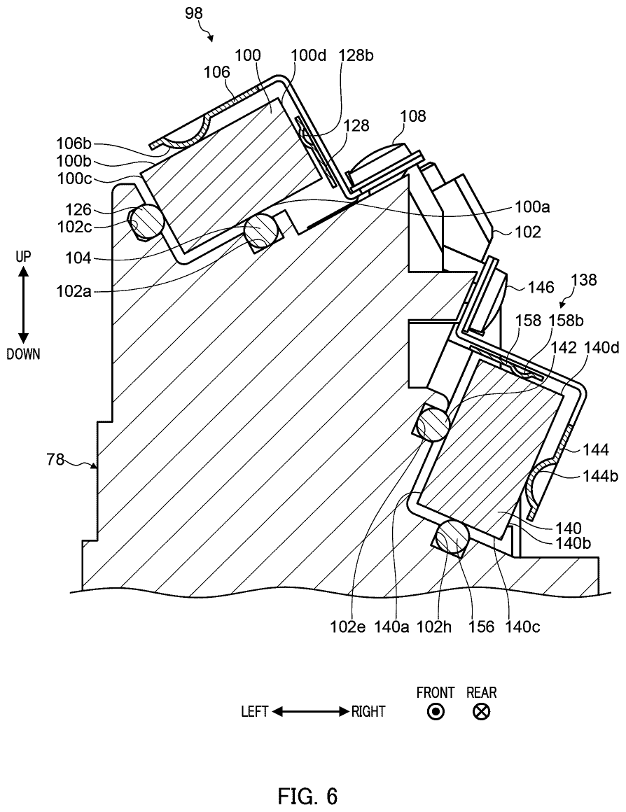

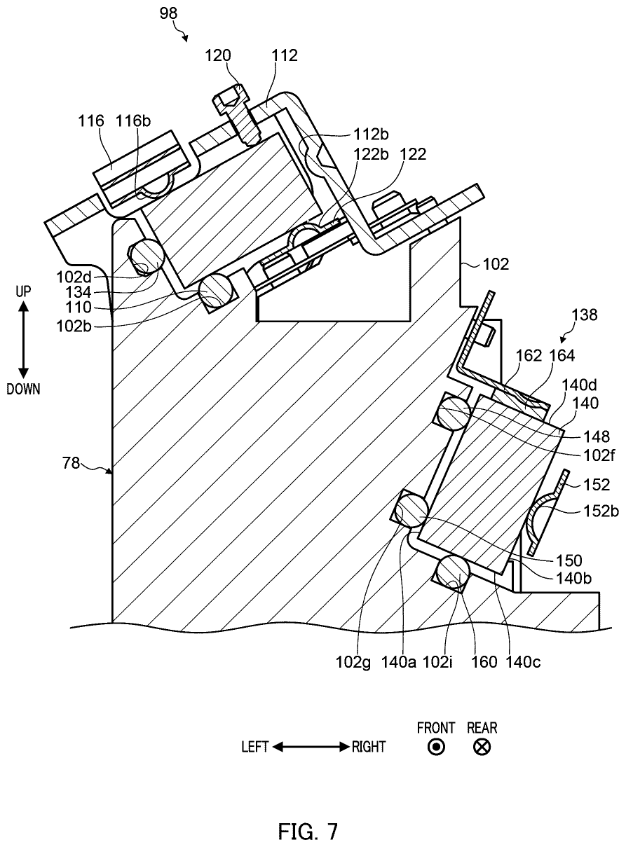

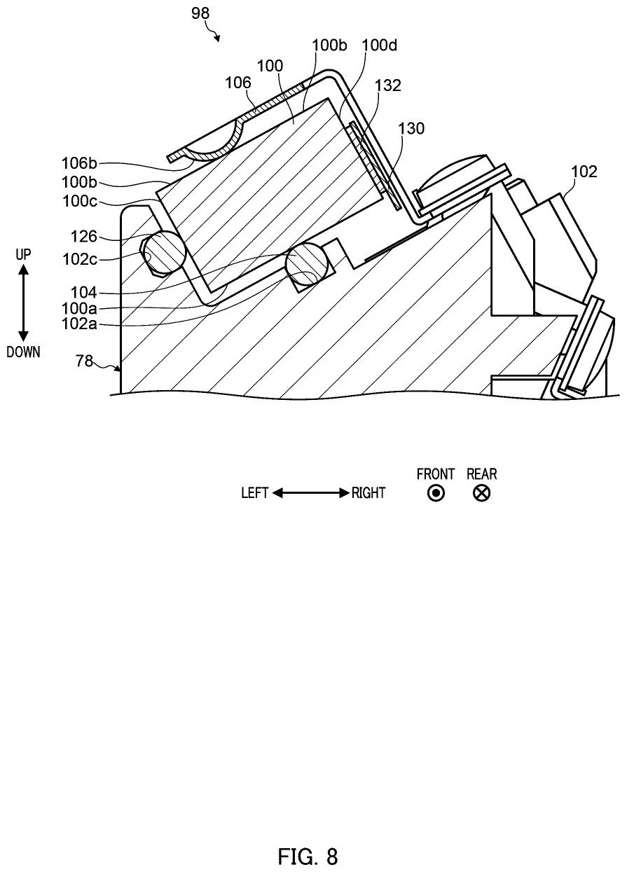

The configuration of an optical apparatus 98 according to Embodiment 1 will be described with reference to FIG. 3 to FIG. 12. FIG. 4 is a schematic left side view of the optical apparatus 98 according to Embodiment 1. FIG. 5 is a schematic right side view of the optical apparatus 98 according to Embodiment 1. FIG. 6 is an enlarged diagram taken along a line VI-VI in FIG. 4. FIG. 7 is an enlarged diagram taken along a line VII-VII in FIG. 4. FIG. 8 is a schematic cross-sectional view of one end side of an optical element 100 in the longitudinal direction thereof in the optical apparatus 98 according to another aspect of Embodiment 1.

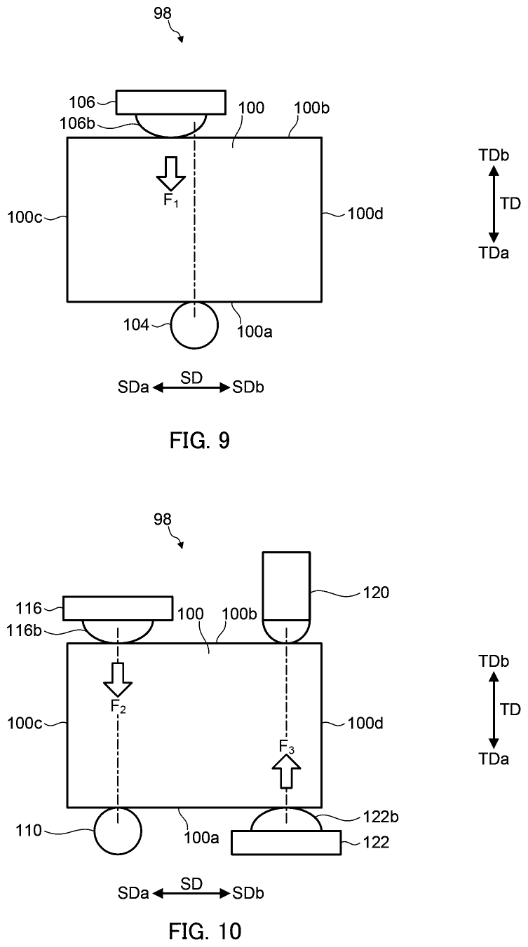

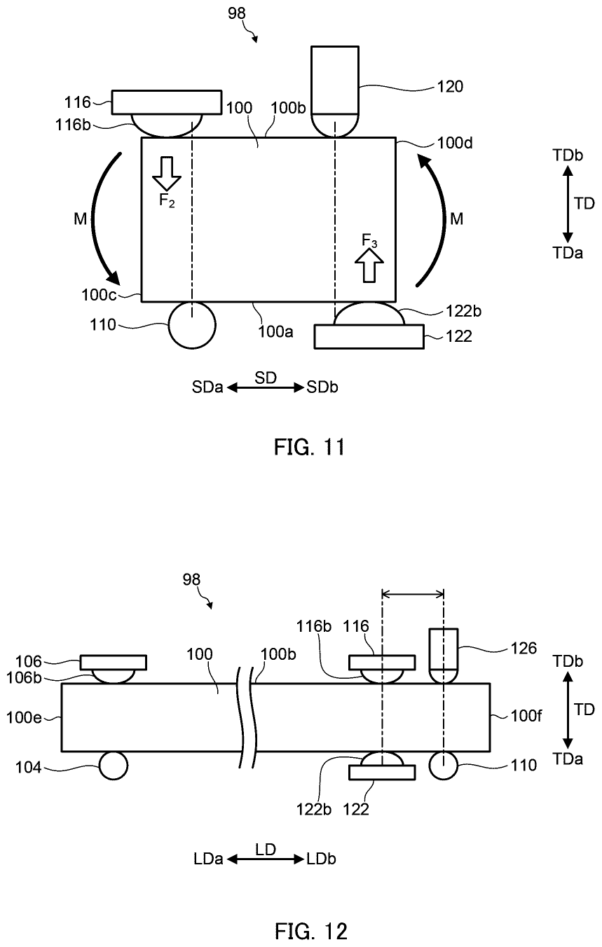

FIG. 9 is a conceptual diagram of the one end side of the optical element 100 in the longitudinal direction thereof in the optical apparatus 98 according to Embodiment 1. FIG. 10 is a conceptual diagram of the other end side of the optical element 100 in the longitudinal direction thereof in the optical apparatus 98 according to Embodiment 1. FIG. 11 is a conceptual diagram of the other end side of the optical element 100 in the longitudinal direction thereof in the optical apparatus 98 according to another aspect of Embodiment 1. FIG. 12 is a conceptual diagram of the optical element 100 along the longitudinal direction thereof in the optical apparatus 98 according to another aspect of Embodiment 1.

As illustrated in FIG. 3 to FIG. 8, the optical apparatus 98 according to Embodiment 1 constitutes a part of the scanning optical apparatus 32 according to the present embodiment. The optical apparatus 98 includes the optical element 100 made of float plate glass, and the optical element 100 is, for example, the fold mirror 92 located on the uppermost side among the plurality of fold mirrors 92. The optical element 100 includes a first surface 100a and a second surface 100b on the both sides thereof, respectively, in the thickness direction thereof. The first surface 100a of the optical element 100 is a reflective surface on which metal, silica dioxide, or the like is vapor-deposited. The second surface 100b of the optical element 100 is a rear surface located on the side opposite to the first surface 100a.

As illustrated in FIG. 4 and FIG. 5, the optical element 100 is installed between a pair of support pillars 102 formed at the housing main body 78. The pair of support pillars 102 is separated from each other in the front-rear direction and constitutes part of the housing main body 78 as an attachment base. One of the support pillars 102 is disposed on one end side (the front end side) of the optical element 100 in the longitudinal direction thereof, and the other one of the support pillars 102 is disposed on the other end side (the rear end side) of the optical element 100 in the longitudinal direction thereof.

As illustrated in FIG. 6 and FIG. 9, at a first recess 102a formed at one of the support pillars 102, a first seating surface member 104 as a first supporter that supports a portion of the first surface 100a of the optical element 100 on a center side of the optical element 100 in the shorter direction thereof is provided. The first seating surface member 104 is disposed on the one end side of the optical element 100 in the longitudinal direction thereof. The support location of the first seating surface member 104 abuts on the portion of the first surface 100a of the optical element 100 on the center side of the optical element 100 in the shorter direction thereof. The first seating surface member 104 is formed of a steel ball, and is configured to be undetachable from the first recess 102a of one of the support pillars 102.

The support location (abutting location) of the first seating surface member 104 is in point contact with the first surface 100a of the optical element 100 and is formed in a spherical shape. Note that, the support location of the first seating surface member 104 may be formed in a shape other than the spherical shape as long as the support location is in point contact with the first surface 100a of the optical element 100. Instead of the first seating surface member 104 supporting the first surface 100a of the optical element 100, the first seating surface member 104 may support a portion of the second surface 100b of the optical element 100 on a center side of the optical element 100 in the shorter direction thereof. In this case, the support location of the first seating surface member 104 abuts on the portion of the second surface 100b of the optical element 100 on the center side of the optical element 100 in the shorter direction thereof.

As illustrated in FIGS. 4, FIG. 6, and FIG. 9, one of the support pillars 102 is provided, via an attachment screw 108 or the like, with a first pressing member 106 that presses the optical element 100 to the side of the first seating surface member 104. The first pressing member 106 is disposed on the one end side of the optical element 100 in the longitudinal direction thereof. The first pressing member 106 is formed of, for example, a plate spring made of metal such as stainless steel. At the first pressing member 106, a boss 106b that abuts on the second surface 100b of the optical element 100 is formed by drawing.

The boss 106b, which is the pressing location (contact location) of the first pressing member 106, is in point contact with the second surface 100b of the optical element 100 and is formed in a spherical shape. Note that, the boss 106b of the first pressing member 106 may be formed in a shape other than the spherical shape as long as the boss 106b is in point contact with the second surface 100b of the optical element 100.

The boss 106b of the first pressing member 106 is shifted from the location, which faces the support location of the first seating surface member 104 with the optical element 100 held therebetween, to one end side of the optical element 100 in the shorter direction thereof. In addition, the position of the support location of the first seating surface member 104 and the position of the boss 106b of the first pressing member 106 in the longitudinal direction of the optical element 100 are the same position, but may be different positions.

As described above, in the optical apparatus 98, the one end side of the optical element 100 in the longitudinal direction thereof can be supported at one point (one location) by the support location of the first seating surface member 104. Supporting at one point refers to supporting one side surface (the first surface 100a or the second surface 100b) of the optical element 100 in the thickness direction thereof at one point.

As illustrated in FIGS. 4, FIG. 7, and FIG. 10, at a second recess 102b formed at the other one of the support pillars 102, a second seating surface member 110 as a second supporter that supports a portion of the first surface 100a of the optical element 100 on the one end side of the optical element 100 in the shorter direction thereof is provided. The second seating surface member 110 is disposed on the other end side of the optical element 100 in the longitudinal direction thereof. The support location of the second seating surface member 110 abuts on the portion of the first surface 100a of the optical element 100 on the one end side of the optical element 100 in the shorter direction thereof. The second seating surface member 110 is formed of a steel ball and is configured to be undetachable from the second recess 102b of the other one of the support pillars 102.

The support location (abutting location) of the second seating surface member 110 is in point contact with the first surface 100a of the optical element 100 and is formed in a spherical shape. Note that, the support location of the second seating surface member 110 may be formed in a shape other than the spherical shape as long as the support location is in point contact with the first surface 100a of the optical element 100.

As illustrated in FIG. 4 and FIG. 7, a support bracket 112 is provided at the other one of the support pillars 102 via an attachment screw 114 or the like, and the support bracket 112 is disposed on the other end side of the optical element 100 in the longitudinal direction thereof. The support bracket 112 is made of sheet metal of metal such as stainless steel, for example, and covers part of the optical element 100 on the other end side of the optical element 100 in the longitudinal direction thereof.

As illustrated in FIGS. 4, FIG. 7, and FIG. 10, the support bracket 112 is provided, via an attachment screw 118 or the like, with a second pressing member 116 that presses the optical element 100 to the side of the second seating surface member 110. The second pressing member 116 is disposed on the other end side of the optical element 100 in the longitudinal direction thereof. The second pressing member 116 is formed of, for example, a plate spring made of metal such as stainless steel. At the second pressing member 116, a boss 116b that abuts on a portion of the second surface 100b of the optical element 100 on the one end side of the optical element 100 in the shorter direction thereof is formed by drawing.

The boss 116b, which is the pressing location (contact location) of the second pressing member 116, is in point contact with the second surface 100b of the optical element 100 and is formed in a spherical shape. Note that, the boss 116b of the second pressing member 116 may be formed in a shape other than the spherical shape as long as the boss 116b is in point contact with the second surface 100b of the optical element 100.

As illustrated in FIG. 7 and FIG. 10, the boss 116b of the second pressing member 116 is located at the location facing the support location of the second seating surface member 110 with the optical element 100 held therebetween. As illustrated in FIG. 11, the boss 116b of the second pressing member 116 may be shifted from the location, which faces the support location of the second seating surface member 110, to the one end side of the optical element 100 in the shorter direction thereof. In addition, the position of the support location of the second seating surface member 110 and the position of the boss 116b of the second pressing member 116 in the longitudinal direction of the optical element 100 are the same position but may be different positions as illustrated in FIG. 12.

As illustrated in FIGS. 4, FIG. 7, and FIG. 10, the support bracket 112 is provided with an adjustment screw 120 serving as a third supporter or an adjustment member that supports a portion of the second surface 100b of the optical element 100 on the other end side thereof in the shorter direction thereof, by screwing together. The adjustment screw 120 is disposed on the other end side of the optical element 100 in the longitudinal direction thereof. The support location of the adjustment screw 120 abuts on the portion of the second surface 100b of the optical element 100 on the other end side thereof in the shorter direction thereof. A rotation operation of the adjustment screw 120 causes the support position of the second surface 100b of the optical element 100 to be disposed. The adjustment screw 120 adjusts the rotation angle of the optical element 100 with the support location of the second seating surface member 110 as a fulcrum by the displacement of the support position of the second surface 100b of the optical element 100. In other words, the adjustment screw 120 adjusts the posture of the optical element 100 with respect to the housing main body 78 by the displacement of the support position of the second surface 100b of the optical element 100.

The leading end portion of the adjustment screw 120, which is the support location (abutting location) thereof, is in point contact with the second surface 100b of the optical element 100 and is formed in a spherical shape. Note that, the leading end portion of the adjustment screw 120 may be formed in a shape other than the spherical shape as long as the leading end portion is in point contact with the second surface 100b of the optical element 100. In addition, the adjustment screw 120 may be provided at an appropriate position of the housing main body 78 instead of being provided at the support bracket 112. The optical apparatus 98 may include an adjustment pin (not illustrated) as an adjustment member in place of the adjustment screw 120.

As illustrated in FIGS. 4, FIG. 7, and FIG. 10, one of the support pillars 102 is provided, via an attachment screw 124 or the like, with a third pressing member 122 that presses the optical element 100 to the side of the adjustment screw 120. The third pressing member 122 is disposed on the other end side of the optical element 100 in the longitudinal direction thereof. The third pressing member 122 is, for example, a plate spring made of metal such as stainless steel. At the third pressing member 122, a boss 122b that abuts on a portion of the first surface 100a of the optical element 100 on the other end side of the optical element 100 in the shorter direction thereof is formed by drawing.

The boss 122b, which is the pressing location (contact location) of the third pressing member 122, is in point contact with the first surface 100a of the optical element 100 and is formed in a spherical shape. Note that, the boss 122b of the third pressing member 122 may be formed in a shape other than the spherical shape as long as the boss 122b is in point contact with the first surface 100a of the optical element 100.

As illustrated in FIG. 7 and FIG. 10, the boss 122b of the third pressing member 122 is located at the location facing the support location of the adjustment screw 120 with the optical element 100 held therebetween. As illustrated in FIG. 11, the boss 122b of the third pressing member 122 may be shifted from the location, which faces the support location of the adjustment screw 120, to the other end side of the optical element 100 in the shorter direction thereof. In addition, the position of the support location of the adjustment screw 120 and the position of the boss 122b of the third pressing member 122 in the longitudinal direction of the optical element 100 are the same position.

As illustrated in FIG. 10 and FIG. 12, the position of the support location of the adjustment screw 120 and the position of the boss 122b of the third pressing member 122 in the longitudinal direction of the optical element 100 may be different positions. The distance in the longitudinal direction of the optical element 100 between the support location of the second seating surface member 110 and the pressing location of the second pressing member 116 may be identical to the distance in the longitudinal direction of the optical element 100 between the support location of the adjustment screw 120 and the pressing location of the third pressing member 122. The bending moment due to the pressing forces F₂ of the second pressing member 116 with the support location of the second seating surface members 110 as a fulcrum and the bending moment due to the pressing forces F₃ of the third pressing member 122 with the support location of the adjustment screws 120 as a fulcrum may act in directions opposite to each other.

As described above, in the optical apparatus 98, the other end side of the optical element 100 in the longitudinal direction thereof can be supported at two points (two locations) by the support location of the second seating surface member 110 and the support location of the adjustment screw 120. Supporting at two points refers to supporting one side surface (the first surface 100a or the second surface 100b) or both side surfaces (the first surface 100a and the second surface 100b) of the optical element 100 in the thickness direction thereof at two points.

In addition, in the optical apparatus 98, by displacing the support position of the second surface 100b of the optical element 100 by the rotation operation of the adjustment screw 120, it is possible to adjust the rotation angle of the optical element 100 with the support location of the second seating surface member 110 as a fulcrum. In other words, the posture of the optical element 100 with respect to the housing main body 78 can be adjusted.

Here, since the one end side of the optical element 100 in the longitudinal direction thereof is supported at one point and the other end side of the optical element 100 in the longitudinal direction thereof is supported at two points, it is possible to smoothly rotate the optical element 100 with the support location of the second seating surface member 110 as a fulcrum. Since the distance between the adjustment screw 120 and the second seating surface member 110 in the longitudinal direction of the optical element 100 can be sufficiently secured, the sensitivity (adjustment sensitivity) of adjusting the posture of the optical element 100 by the rotation operation of the adjustment screw 120 can be reduced.

As illustrated in FIG. 9 to FIG. 11, the second pressing member 116 and the third pressing member 122 correspond to a presser that presses the optical element 100 to the side of the second seating surface member 110 and the side of the adjustment screw 120. A pressing force (F₂+F₃) of the second pressing member 116 and the third pressing member 122 as the presser is set to be larger than a pressing force F₁ of the first pressing member 106. The pressing force (F₂+F₃) of the second pressing member 116 and the third pressing member 122 may be set to be larger than twice the pressing force F₁ of the first pressing member 106. A pressing force F₂ of the second pressing member 116 may be set to be larger than the pressing force F₁ of the first pressing member 106. A pressing force F₃ of the third pressing member 122 may be set to be larger than the pressing force F₁ of the first pressing member 106.

In order to set the pressing force F₂ of the second pressing member 116 and the pressing force F₃ of the third pressing member 122 as described above, the shapes, thicknesses, materials, or the like of the second pressing member 116 and the third pressing member 122 may be different from the shape, thickness, material, or the like of the first pressing member 106. Each of the second pressing member 116 and the third pressing member 122 may be formed by stacking two plate springs that are the same as the plate spring forming the first pressing member 106.

As illustrated in FIG. 6, at a third recess 102c formed at one of the support pillars 102, a side-surface seating surface member 126 as a side-surface supporter that supports a side surface 100c on the one end side of the optical element 100 in the shorter direction thereof is provided. The side-surface seating surface member 126 is disposed on the other end side of the optical element 100 in the longitudinal direction thereof. The support location of the side-surface seating surface member 126 abuts on the side surface 100c of the optical element 100. The side-surface seating surface member 126 is formed of a steel ball, and is configured to be undetachable from the third recess 102c of one of the support pillars 102.

The support location of the side-surface seating surface member 126 is in point contact with the side surface 100c of the optical element 100 and is formed in a spherical shape. Note that, the support location of the side-surface seating surface member 126 may be formed in a shape other than the spherical shape as long as the support location is in point contact with the side surface 100c of the optical element 100.

As illustrated in FIG. 4 and FIG. 6, at one of the support pillars 102, a side-surface pressing member 128 that presses the optical element 100 to the side of the side-surface seating surface member 126. The side-surface pressing member 128 is disposed on the one end side of the optical element 100 in the longitudinal direction thereof. The side-surface pressing member 128 is, for example, a plate spring made of metal such as stainless steel. At the side-surface pressing member 128, a boss 128p that abuts on a side surface 100d of the optical element 100 on the other end side thereof in the shorter direction thereof is formed by drawing.

The boss 128b, which is the pressing location (contact location) of the side-surface pressing member 128, is in point contact with the side surface 100d of the optical element 100 on the other end side thereof in the shorter direction thereof and is formed in a spherical shape. Note that, the boss 128b of the side-surface pressing member 128 may be formed in a shape other than the spherical shape as long as the boss 128b is in point contact with the side surface 100d of the optical element 100.

The boss 128b of the side-surface pressing member 128 is located at the location facing the support location of the side-surface seating surface member 126 with the optical element 100 held therebetween. The boss 128b of the side-surface pressing member 128 may be shifted from the location, which faces the support location of the side-surface seating surface member 126, in the thickness direction of the optical element 100. In addition, the position of the support location of the side-surface seating surface member 126 and the position of the boss 128b of the side-surface pressing member 128 in the longitudinal direction of the optical element 100 are the same position, but may be different positions.

At the side-surface pressing member 128, another boss (not illustrated) that abuts on the end surface of the optical element 100 on the other end side thereof in the longitudinal direction thereof is formed by drawing. The other boss of the side-surface pressing member 128 is in point contact with the end surface of the optical element 100 on the other end side thereof in the longitudinal direction thereof. The boss of the side-surface pressing member 128 is formed in a spherical shape.

Instead of providing one of the support pillars 102 with the side-surface pressing member 128 formed of a plate spring, the following configuration may be adopted. As illustrated in FIG. 8, one of the support pillars 102 may be provided with a holding bracket 130 formed of sheet metal. Another side-surface pressing member 132 formed of, for example, an elastic body such as a vibration-proof rubber may be provided between the rear surface of the holding bracket 130 and the side surface 100d of the optical element 100 on the other end side thereof in the shorter direction thereof. The other side-surface pressing member 132 presses the optical element 100 to the side of the side-surface seating surface member 126 by the elastic force of the other side-surface pressing member 132.

As illustrated in FIG. 7, at a fourth recess 102d formed at the other one of the support pillars 102, a side-surface seating surface member 134 as a side-surface supporter that supports the side surface 100c of the optical element 100 on the one end side thereof in the shorter direction thereof is provided. The side-surface seating surface member 134 is disposed on the other end side of the optical element 100 in the longitudinal direction thereof. The support location of the side-surface seating surface member 134 abuts on the side surface 100c of the optical element 100. The side-surface seating surface member 134 is formed of a steel ball, and is configured to be undetachable from the fourth recess 102d of the other one of the support pillars 102.

The support location (abutting location) of the side-surface seating surface member 134 is in point contact with the side surface 100c of the optical element 100 and is formed in a spherical shape. Note that, the support location of the side-surface seating surface member 134 may be formed in a shape other than the spherical shape as long as the support location is in point contact with the side surface 100c of the optical element 100.

At the support bracket 112, the boss 106b that is close to the side surface 100d of the optical element 100 on the other end side thereof in the shorter direction thereof, for example, in a state of being separated by about 0.5 mm, is formed by drawing. A boss 112b of the support bracket 112 is formed in a spherical shape. The boss 112b of the support bracket 112 may abut on the side surface 100d of the optical element 100.

The boss 112b of the support bracket 112 is located at the location facing the support location of the side-surface seating surface member 134 with the optical element 100 held therebetween. The boss 112b of the support bracket 112 may be shifted from the location, which faces the support location of the side-surface seating surface member 134, in the thickness direction of the optical element 100. In addition, the position of the support location of the side-surface seating surface member 134 and the position of the boss 112b of the support bracket 112 in the longitudinal direction of the optical element 100 are the same position, but may be different positions.

Here, the side-surface seating surface member 134 and the boss 112b of the support bracket 112 correspond to a falling-off regulator that regulates the falling off of the optical element 100 from the second seating surface member 110 and the adjustment screw 120 by regulating the movement of the optical element 100 in the in-plane direction. In other words, the optical apparatus 98 includes the side-surface seating surface member 134 and the boss 112b of the support bracket 112 as the falling-off regulator. The in-plane direction of the optical element 100 refers to the direction orthogonal to the thickness direction of the optical element 100. In addition, as the falling-off regulator, the side-surface seating surface member 134 and the boss 112b of the support bracket 112 are configured to be in a non-pressing state with respect to the optical element 100 as described above.

At the support bracket 112, another boss (not illustrated) that abuts on the end surface of the optical element 100 on the one end side thereof in the longitudinal direction thereof is formed by drawing. The other boss of the support bracket 112 is in point contact with the end surface of the optical element 100 on the other end side thereof in the longitudinal direction thereof. The other boss, which is the support location of the support bracket 112, is formed in a spherical shape.

As illustrated in FIG. 4 and FIG. 5, a reinforcement member 136 is attached to a central portion of the second surface 100b of the optical element 100 in the longitudinal direction of the optical element 100. The reinforcement member 136 extends in the longitudinal direction of the optical element 100 and is made of sheet metal.

According to the configuration of the optical apparatus 98 in Embodiment 1, the pressing force (F₂+F₃) of the second pressing member 116 and the third pressing member 122 is set to be larger than the pressing force F₁ of the first pressing member 106 as described above. For this reason, the optical element 100 can be pressed to the side of the second seating surface member 110 and the side the adjustment screw 120 with a strong force in comparison with a case where the pressing force (F₂+F₃) of the second pressing member 116 and the third pressing member 122 is the same as the pressing force F₁ of the first pressing member 106.

Accordingly, in a case where the one end side of the optical element 100 in the longitudinal direction thereof is supported at one point and the other end side thereof in the longitudinal direction thereof is supported at two points, the optical apparatus 98 of Embodiment 1 makes it possible to suppress the floating of the optical element 100 from the second seating surface member 110 and the adjustment screw 120. As a result, it is possible to reduce the rotational vibration of the optical element 100 around the axis along the longitudinal direction of the optical element 100 and enhance the image quality of the image forming apparatus 10. In particular, in a case where the optical element 100 is the fold mirror 92 (an example of a mirror), it is possible to reduce the influence of the rotational vibration of the optical element 100 on the traveling direction of the laser light B as the scanning light.

In addition, according to the configuration of the optical apparatus 98 according to Embodiment 1, the pressing force (F₂+F₃) of the second pressing member 116 and the third pressing member 122 is set to be larger than twice the pressing force F₁ of the first pressing member 106 as described above. For this reason, the optical element 100 can be pressed to the side of the second seating surface member 110 and the side of the adjustment screw 120 with a strong force in comparison with a case where the pressing force (F₂+F₃) of the second pressing member 116 and the third pressing member 122 is the same as the pressing force F₁ of the first pressing member 106.

Accordingly, even when there is a variation in the rotational moment of the optical element 100 due to the pressing force F₁ of the first pressing member 106, the optical apparatus 98 of Embodiment 1 makes it possible to further suppress the floating of the optical element 100 from the second seating surface member 110 and the adjustment screw 120.

In addition, according to the configuration of the optical apparatus 98 according to Embodiment 1, each of the pressing force F₂ of the second pressing member 116 and the pressing force F₃ of the third pressing member 122 is set to be larger than the pressing force F₁ of the first pressing member 106 as described above. For this reason, the optical element 100 can be stably pressed to the side of the second seating surface member 110 and the side of the adjustment screw 120 with a strong force.

Accordingly, the optical apparatus 98 according to Embodiment 1 makes it possible to stably suppress the floating of the optical element 100 from the second seating surface member 110 and the adjustment screw 120.

In addition, according to the configuration of the optical apparatus 98 according to Embodiment 1, the distance between the support location of the second seating surface member 110 and the pressing location of the second pressing member 116 is identical to the distance between the support location of the adjustment screw 120 and the pressing location of the third pressing member 122. The bending moment due to the pressing force F₂ of the second pressing member 116 with the support location of the second seating surface member 110 as a fulcrum and the bending moment due to the pressing force F₃ of the third pressing member 122 with the support location of the adjustment screw 120 as a fulcrum act in directions opposite to each other. For this reason, the bending moment due to the pressing force F₂ of the second pressing member 116 and the bending moment due to the pressing force F₃ of the third pressing member 122 cancel each other.

Accordingly, the optical apparatus 98 of Embodiment 1 makes it possible to suppress bending deformation of the optical element 100.

In addition, according to the configuration of the optical apparatus 98 according to Embodiment 1, each of the first seating surface member 104 and the second seating surface member 110 supports the first surface 100a of the optical element 100 as described above. For this reason, it is possible to simultaneously process the first recess 102a, which is the installation place of the first seating surface member 104, and the second recess 102b, which is the installation place of the second seating surface member 110, in the same step.

Accordingly, the optical apparatus 98 of Embodiment 1 makes it possible to increase the processing accuracy of the first recess 102a and the second recess 102b.

In particular, in a case where the first surface 100a of the optical element 100 is the reflection surface of the fold mirror 92, positional errors in the reflection surface of the fold mirror 92 can be reduced even when dimensional errors in the thickness direction of the optical element 100 occur.

In addition, according to the configuration of the optical apparatus 98 according to Embodiment 1, the side-surface seating surface member 126 supports the side surface 100c of the optical element 100 on the one end side thereof in the shorter direction thereof as described above. The side-surface pressing member 128 presses the optical element 100 to the side of the side-surface seating surface member 126. For this reason, the optical element 100 can be stably held by the friction force between the side-surface seating surface member 126 and the optical element 100 and the friction force between the side-surface pressing member 128 and the optical element 100. In particular, in a case where the side-surface seating surface member 126 and the side pressing member 128 are disposed on the other end side of the optical element 100 in the longitudinal direction thereof, the optical element 100 can be stably and effectively held.

Accordingly, the optical apparatus 98 according to Embodiment 1 makes it possible to further suppress the floating of the optical element 100 from the second seating surface member 110 and the adjustment screw 120 to further reduce the rotational vibration of the optical element 100.

In addition, according to the configuration of the optical apparatus 98 according to Embodiment 1, the side-surface seating surface member 134 and the boss 112b of the support bracket 112 as the falling-off regulator regulate the falling-off of the optical element 100 from the second seating surface member 110 and the adjustment screw 120 as described above. The side-surface seating surface member 134 and the boss 112b of the support bracket 112 are configured as the falling-off regulator to be in a non-pressing state with respect to the optical element 100. For this reason, while preventing the friction force among the side-surface seating surface member 134, the boss 112b of the support bracket 112, and the optical element 100 from becoming excessively large, it is possible to suppress the floating of the optical element 100 from the adjustment screw 120 by the friction force.

Accordingly, the optical apparatus 98 of Embodiment 1 makes it possible to enhance the followability of the optical element 100 in association with an operation (rotation operation) of the adjustment screw 120 and to improve the workability of the adjustment work of the optical element 100.

In addition, according to the configuration of the optical apparatus 98 according to Embodiment 1, the reinforcement member 136 is attached to the central portion of the second surface 100b of the optical element 100 in the longitudinal direction of the optical element 100 as described above. For this reason, even when a rotational moment that presses the optical element 100 to the side of the second seating surface member 110 and the side of the adjustment screw 120 is generated, torsional deformation of the optical element 100 can be suppressed.

Accordingly, the optical apparatus 98 according to Embodiment 1 makes it possible to suppress the influence of the above rotational moment on the performance of the optical apparatus 98.

In addition, according to the configuration of the optical apparatus 98 according to Embodiment 1, each of the boss 106b of the first pressing member 106, the boss 116b of the second pressing member 116, and the boss 122b of the third pressing member 122 is in point contact with the optical element 100 as described above. For this reason, in comparison with the case of line contact or surface contact with the optical element 100, the boss 106b of the first pressing member 106 or the like can be stably brought into contact with the optical element 100 to reduce the friction between the boss 106b of the first pressing member 106 or the like and the optical element 100. In particular, by forming the boss 106b of the first pressing member 106 or the like in a spherical shape, it is possible to bring the boss 106b of the first pressing member 106 or the like into contact with the optical element 100 more stably to further reduce the friction between the boss 106b of the first pressing member 106 or the like and the optical element 100.

Accordingly, the optical apparatus 98 of Embodiment 1 makes it possible to further suppress the floating of the optical element 100 from the second seating surface member 110 and the adjustment screw 120, and to enhance the followability of the optical element 100 in association with the operation of the adjustment screw 120.

In addition, according to the configuration of the optical apparatus 98 according to Embodiment 1, each of the support location of the first seating surface member 104, the support location of the second seating surface member 110, and the support location of the adjustment screw 120 is in point contact with the optical element 100 as described above. For this reason, in comparison with the case of line contact or surface contact with the optical element 100, it is possible to bring the support location of the first seating surface member 104 or the like into contact with the optical element 100 stably to reduce the friction between the support location of the first seating surface member 104 or the like and the optical element 100. In particular, by forming the support location of the first seating surface member 104 or the like in a spherical shape, it is possible to bring the support location of the first seating surface member 104 or the like into contact with the optical element 100 more stably to further reduce the friction between the support location of the first seating surface member 104 or the like and the optical element 100.

Accordingly, the optical apparatus 98 of Embodiment 1 makes it possible to further suppress the floating of the optical element 100 from the second seating surface member 110 and the adjustment screw 120, and to enhance the followability of the optical element 100 in association with the operation of the adjustment screw 120.

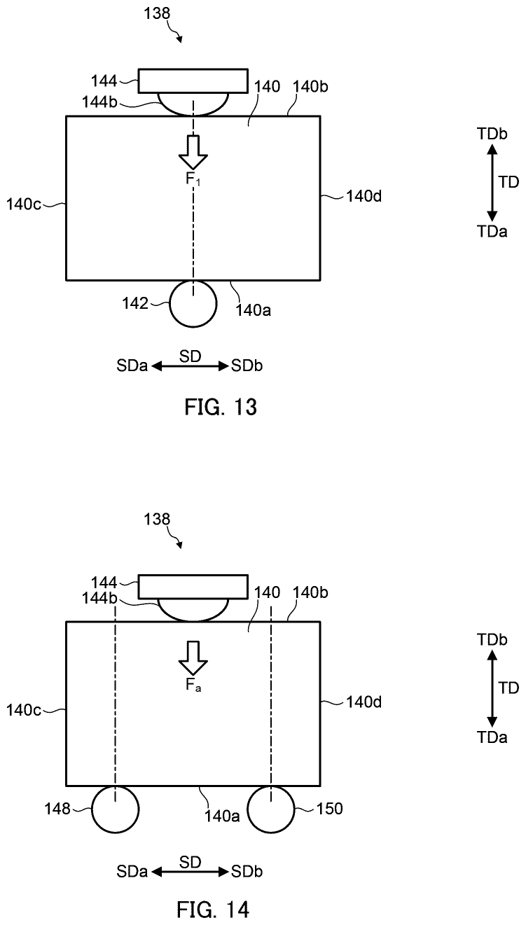

The configuration of an optical apparatus 138 according to Embodiment 2 will be described with reference to FIG. 3 to FIG. 7, FIG. 13 and FIG. 14. FIG. 13 is a conceptual diagram of one end side of an optical element 140 in the longitudinal direction thereof in the optical apparatus 138 according to Embodiment 2. FIG. 14 is a conceptual diagram of the other end side of the optical element 140 in the longitudinal direction thereof in the optical apparatus 138 according to Embodiment 2.

As illustrated in FIG. 3 to FIG. 5, the optical apparatus 138 according to Embodiment 2 constitutes a part of the scanning optical apparatus 32 according to the present embodiment. The optical apparatus 138 includes an optical element 140 formed of float plate glass, and the optical element 140 is, for example, the fold mirror 92 located on the rightmost side among the plurality of fold mirrors 92. The optical element 140 includes a first surface 140a and a second surface 140b on the both sides thereof, respectively, in the thickness direction thereof. The first surface 140a of the optical element 140 is a reflective surface on which metal, silica dioxide, or the like is vapor-deposited. The second surface 140b of the optical element 140 is a rear surface located on the side opposite to the first surface 140a. In addition, the optical element 140 is installed between the pair of support pillars 102 formed at the housing main body 78.

As illustrated in FIG. 6 and FIG. 13, at a fifth recess 102e formed at one of the support pillars 102, a first seating surface member 142 as a first supporter that supports a portion of the first surface 140a of the optical element 140 on a center side of the optical element 140 in the shorter direction thereof is provided. The first seating surface member 142 is disposed on the one end side of the optical element 140 in the longitudinal direction thereof. The support location of the first seating surface member 142 abuts on the portion of the first surface 140a of the optical element 140 on the center side of the optical element 140 in the shorter direction thereof. The first seating surface member 142 is formed of a steel ball, and is configured to be undetachable from the fifth recess 102e of one of the support pillars 102.

The support location (abutting location) of the first seating surface member 142 is in point contact with the first surface 140a of the optical element 140 and is formed in a spherical shape. Note that, the support location of the first seating surface member 142 may be formed in a shape other than the spherical shape as long as the support location is in point contact with the first surface 140a of the optical element 140. Instead of the first seating surface member 142 supporting the first surface 140a of the optical element 140, the first seating surface member 142 may support a portion of the second surface 140b of the optical element 140 on a center side of the optical element 140 in the shorter direction thereof. In this case, the support location of the first seating surface member 142 abuts on the portion of the second surface 140b of the optical element 140 on the center side of the optical element 140 in the shorter direction thereof.

As illustrated in FIGS. 5, FIG. 6, and FIG. 13, one of the support pillars 102 is provided, via an attachment screw 146 or the like, with a first pressing member 144 that presses the optical element 140 to the side of the first seating surface member 142. The first pressing member 144 is disposed on the one end side of the optical element 140 in the longitudinal direction thereof. The first pressing member 144 is formed of, for example, a plate spring made of metal such as stainless steel. At the first pressing member 144, a boss 144b that abuts on the second surface 140b of the optical element 140 is formed by drawing.

The boss 144b, which is the pressing location (contact location) of the first pressing member 144, is in point contact with the second surface 140b of the optical element 140 and is formed in a spherical shape. Note that, the boss 144b of the first pressing member 144 may be formed in a shape other than the spherical shape as long as the boss 144b is in point contact with the second surface 140b of the optical element 140.

The boss 144b of the first pressing member 144 is located at the location facing the support position of the first seating surface member 142 with the optical element 140 held therebetween. In addition, the position of the support location of the first seating surface member 142 and the position of the boss 144b of the first pressing member 144 in the longitudinal direction of the optical element 140 are the same position, but may be different positions.

As described above, in the optical apparatus 138, the one end side of the optical element 140 in the longitudinal direction thereof can be supported at one point (one location) by the support location of the first seating surface member 142. Supporting at one point refers to supporting one side surface (the first surface 140a or the second surface 140b) of the optical element 140 in the thickness direction thereof at one point.

As illustrated in FIG. 7, at a sixth recess 102f formed at the other one of the support pillars 102, a second seating surface member 148 as a second supporter that supports a portion of the first surface 140a of the optical element 140 on the one end side of the optical element 140 in the shorter direction thereof is provided. The second seating surface member 148 is disposed on the other end side of the optical element 140 in the longitudinal direction thereof. The support location of the second seating surface member 148 abuts on the portion of the first surface 140a of the optical element 140 on the one end side of the optical element 140 in the shorter direction thereof. The second seating surface member 148 is formed of a steel ball, and is configured to be undetachable from the sixth recess 102f of the other one of the support pillars 102.

The support location (abutting location) of the second seating surface member 148 is in point contact with the first surface 140a of the optical element 140 and is formed in a spherical shape. Note that, the support location of the second seating surface member 148 may be formed in a shape other than the spherical shape as long as the support location is in point contact with the first surface 140a of the optical element 140.

At a seventh recess 102g formed at the other one of the support pillars 102, a third seating surface member 150 as a third supporter that supports a portion of the first surface 140a of the optical element 140 on the other end side of the optical element 140 in the shorter direction thereof is provided. The third seating surface member 150 is disposed on the other end side of the optical element 100 in the longitudinal direction thereof. The third seating surface member 150 abuts on the portion of the first surface 140a of the optical element 140 on the other end side of the optical element 140 in the shorter direction thereof. The third seating surface member 150 is formed of a steel ball, and is configured to be undetachable from the seventh recess 102g of the other one of the support pillars 102.

The support location (abutting location) of the third seating surface member 150 is in point contact with the first surface 140a of the optical element 140 and is formed in a spherical shape. The support location of the third seating surface member 150 may be formed in a shape other than the spherical shape as long as the support location is in point contact with the first surface 140a of the optical element 140. In addition, the position of the support location of the second seating surface member 148 and the position of the support location of the third seating surface member 150 in the longitudinal direction of the optical element 140 are the same position, but may be different positions.

As illustrated in FIGS. 5, FIG. 7, and FIG. 14, the other one of the support pillars 102 is provided, via an attachment screw 154 or the like, with a presser 152 that presses the optical element 140 to the side of the second seating surface member 148 and the side of the third seating surface member 150. The presser 152 presses a location of the second surface 140b of the optical element 140 between a location facing the support location of the second seating surface member 148 and a location facing the support location of the third seating surface member 150 with the optical element 140 held therebetween. The presser 152 is disposed on the other end side of the optical element 140 in the longitudinal direction thereof. The presser 152 is formed of, for example, a plate spring of metal such as stainless steel. At the presser 152, a boss 152b that abuts on the second surface 140b of the optical element 140 is formed by drawing.

The boss 152b, which is the pressing location (contact location) of the presser 152, is in point contact with the second surface 140b of the optical element 140 and is formed in a spherical shape. The boss 152b of the presser 152 may be formed in a shape other than the spherical shape as long as the boss 152b is in point contact with the second surface 140b of the optical element 140. In addition, the position of the support location of the second seating surface member 148 (the third seating surface member 150) and the position of the boss 152b of the presser 152 in the longitudinal direction of the optical element 140 are the same position, but may be different positions.

As described above, in the optical apparatus 138, the other end side of the optical element 140 in the longitudinal direction thereof can be supported at two points (two locations) by the support location of the second seating surface member 148 and the support location of the third seating surface member 150. Supporting at two points refers to supporting one side surface (the first surface 140a or the second surface 140b) or both side surfaces (the first surface 140a and the second surface 140b) of the optical element 140 in the thickness direction thereof at two points.

As illustrated in FIG. 13 and FIG. 14, a pressing force Fa of the presser 152 is set to be larger than a pressing force F₁ of a first pressing member 144. The pressing force Fa of the presser 152 may be set to be larger than twice the pressing force F₁ of the first pressing member 144. In order to set the pressing force Fa of the presser 152 as described above, the shape, thickness, material, or the like of the presser 152 may be different from the shape, thickness, material, or the like of the first pressing member 144. The presser 152 may be formed by stacking two leaf springs which are the same as the leaf spring forming the first pressing member 144.

As illustrated in FIGS. 5, FIG. 6, and FIG. 13, at an eighth recess 102h formed at one of the support pillars 102, a side-surface seating surface member 156 as a side-surface supporter that supports a side surface 140c on the one end side of the optical element 140 in the shorter direction thereof is provided. The side-surface seating surface member 156 is disposed on the one end side of the optical element 140 in the longitudinal direction thereof. The support location of the side-surface seating surface member 156 abuts on the side surface 140c of the optical element 140. The side-surface seating surface member 156 is formed of a steel ball, and is configured to be undetachable from the eighth recess 102h of one of the support pillars 102.

The support location (abutting location) of the side-surface seating surface member 156 is in point contact with the side surface 140c of the optical element 140 and is formed in a spherical shape. Note that, the support location of the side-surface seating surface member 156 may be formed in a shape other than the spherical shape as long as the support location is in point contact with the side surface 140c of the optical element 140.

As illustrated in FIG. 5 and FIG. 6, at one of the support pillars 102, a side-surface pressing member 158 that presses the optical element 140 to the side of the side-surface seating surface member 156 is provided, and the side-surface pressing member 158 is disposed on the one end side of the optical element 140 in the longitudinal direction thereof. The side-surface pressing member 158 is, for example, a plate spring made of metal such as stainless steel. At the side-surface pressing member 158, a boss 158b that abuts on a side surface 140d of the optical element 140 on the other end side thereof in the shorter direction thereof is formed by drawing.

The boss 158b, which is the pressing location (contact location) of the side-surface pressing member 158, is in point contact with the side surface 140d of the optical element 140 and is formed in a spherical shape. Note that, the boss 158b of the side-surface pressing member 158 may be formed in a shape other than the spherical shape as long as the boss 158b is in point contact with the side surface 140d of the optical element 140.

The boss 158b of the side-surface pressing member 158 is located at the location facing the support location of the side-surface seating surface member 156 with the optical element 140 held therebetween. The boss 158b of the side-surface pressing member 158 may be shifted from the location, which faces the support position of the side-surface seating surface member 156, in the thickness direction of the optical element 140. In addition, the position of the boss 158b of the side-surface pressing member 158 and the position of the support location of the side-surface seating surface member 156 in the longitudinal direction of the optical element 140 are the same position, but may be different positions.

At the side-surface pressing member 158, another boss (not illustrated) that abuts on the end surface of the optical element 140 on the one end side in the longitudinal direction thereof is formed by drawing. The other boss of the side-surface pressing member 158 is in point contact with the end surface of the optical element 140 on the one end side thereof in the longitudinal direction thereof. The other boss of the side-surface pressing member 158 is formed in a spherical shape.

As illustrated in FIG. 7, at a ninth recess 102i formed at the other one of the support pillars 102, a side-surface seating surface member 160 as a side-surface supporter that supports the side surface 140d of the optical element 140 on the other end side thereof in the shorter direction thereof is provided. The side-surface seating surface member 160 is disposed on the other end side of the optical element 140 in the longitudinal direction thereof. The support location of the side-surface seating surface member 160 abuts on the side surface 140d of the optical element 140. The side-surface seating surface member 160 is formed of a steel ball, and is configured to be undetachable from the ninth recess 102i of the other one of the support pillars 102.

The support location (abutting location) of the side-surface seating surface member 160 is in point contact with the side surface 140c of the optical element 140 and is formed in a spherical shape. Note that, the support location of the side-surface seating surface member 160 may be formed in a shape other than the spherical shape as long as the support location is in point contact with the side surface 140c of the optical element 140.

As illustrated in FIG. 7, the other one of the support pillars 102 is provided with a holding bracket 162, and the holding bracket 162 is formed of sheet metal. A side-surface pressing member 164 having a plate shape, which presses the optical element 140 to the side of the side-surface seating surface member 160, is provided between the rear surface of the holding bracket 162 and the side surface 140d of the optical element 140. The side-surface pressing member 164 is made of, for example, an elastic body such as a vibration-proof rubber.

At the holding bracket 162, a boss (not illustrated) that abuts on the end surface of the optical element 140 on the other end side thereof in the longitudinal direction thereof is formed by drawing. The boss of the holding bracket 162 is in point contact with the end surface of the optical element 140 on the other end side thereof in the longitudinal direction thereof. The boss of the holding bracket 162 is formed in a spherical shape.

As illustrated in FIG. 5, a reinforcement member 166 is attached to a central portion of the second surface 140b of the optical element 140 in the longitudinal direction of the optical element 140. The reinforcement member 166 extends in the longitudinal direction of the optical element 140 and is made of sheet metal.

According to the configuration of the optical apparatus 138 according to Embodiment 2, the pressing force Fa of the presser 152 is set to be larger than the pressing force F₁ of the first pressing member 144 as described above. For this reason, the optical element 140 can be pressed to the side of the second seating surface member 148 and the side of the third seating surface member 150 with a strong force in comparison with a case where the pressing force Fa of the presser 152 is the same as the pressing force F₁ of the first pressing member 144.

Accordingly, in a case where the one end side of the optical element 140 in the longitudinal direction thereof is supported at one point and the other end side of the optical element 140 in the longitudinal direction thereof is supported at two points, the optical apparatus 138 of Embodiment 2 makes it possible to suppress the floating of the optical element 140 from the second seating surface member 148 and the third seating surface member 150. As a result, it is possible to reduce the rotational vibration of the optical element 140 around the axis along the longitudinal direction of the optical element 140 and enhance the image quality of the image forming apparatus 10. In particular, in a case where the optical element 140 is the fold mirror 92 (an example of a mirror), it is possible to reduce the influence of the rotational vibration of the optical element 140 on the traveling direction of the laser light B as the scanning light.

In addition, according to the configuration of the optical apparatus 138 of Embodiment 2, the pressing force Fa of the presser 152 is set to be larger than twice the pressing force F₁ of the first pressing member 144 as described above. For this reason, the optical element 140 can be pressed to the side of the second seating surface member 148 and the side of the third seating surface member 150 with a strong force in comparison with a case where the pressing force Fa of the presser 152 is the same as the pressing force F₁ of the first pressing member 144.

Accordingly, even when there is a variation in the rotational moment of the optical element 140 due to the pressing force F₁ of the first pressing member 144, the optical apparatus 138 of Embodiment 2 makes it possible to further suppress the floating of the optical element 140 from the second seating surface member 148 or the like.

In addition, according to the configuration of the optical apparatus 138 according to Embodiment 2, each of the first seating surface member 142 and the second seating surface member 148 supports the first surface 140a of the optical element 140 as described above. For this reason, it is possible to simultaneously process the fifth recess 102e, which is the installation place of the first seating surface member 142, and the sixth recess 102f, which is the installation place of the second seating surface member 148, in the same step.

Accordingly, the optical apparatus 138 of Embodiment 2 makes it possible to increase the processing accuracy of the fifth recess 102e and the sixth recess 102f.

In particular, in a case where the first surface 140a of the optical element 140 is the reflecting surface of the fold mirror 92, positional errors in the reflecting surface of the fold mirror 92 can be reduced even when dimensional errors in the thickness direction of the optical element 140 occur.

In addition, according to the configuration of the optical apparatus 138 according to Embodiment 2, the side-surface seating surface member 156 supports the side surface 140c on the one end side of the optical element 140 in the shorter direction thereof as described above. The side-surface pressing member 158 presses the optical element 140 to the side of the side-surface seating surface member 156. For this reason, the optical element 140 can be stably held by the friction force between the side-surface seating surface member 156 and the optical element 140 and the friction force between the side-surface pressing member 158 and the optical element 140.

Accordingly, the optical apparatus 138 of Embodiment 2 makes it possible to further suppress the floating of the optical element 140 from the second seating surface member 148 and the third seating surface member 150 to further reduce the rotational vibration of the optical element 140.

In addition, according to the configuration of the optical apparatus 138 according to Embodiment 2, the reinforcement member 166 is attached to the central portion of the second surface 140b of the optical element 140 in the longitudinal direction of the optical element 140 as described above. For this reason, even when a rotational moment that presses the optical element 140 against the second seating surface member 148 and the third seating surface member 150 is generated, torsional deformation of the optical element 140 can be suppressed.

Accordingly, the optical apparatus 138 according to Embodiment 2 makes it possible to suppress the influence of the above rotational moment on the performance of the optical apparatus 138.

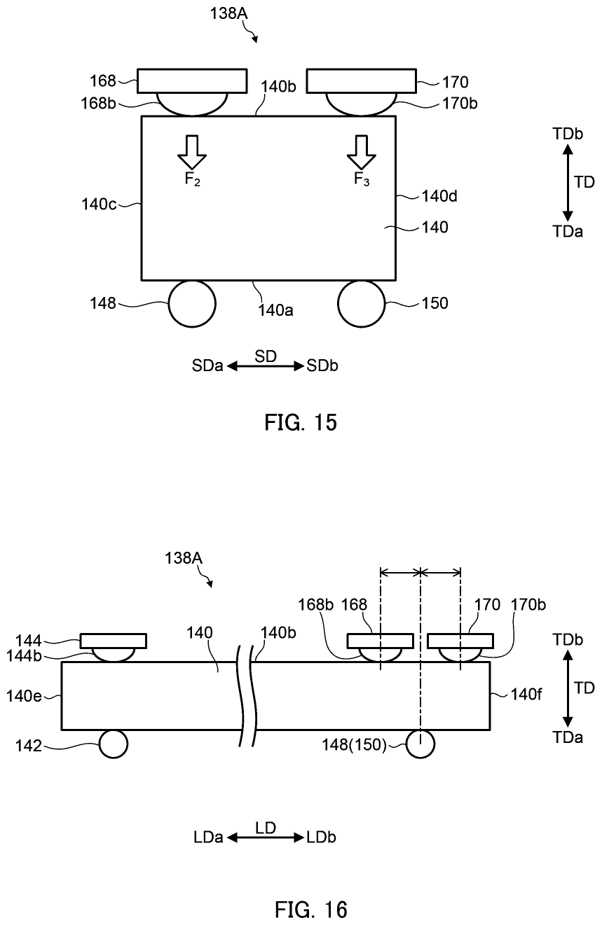

The configuration of an optical apparatus 138A according to a variation of Embodiment 2 will be described with reference to FIGS. 3, FIG. 15, and FIG. 16. FIG. 15 is a conceptual diagram of the other end side of the optical element 140 in the longitudinal direction thereof in the optical apparatus 138A according to the variation of Embodiment 2. FIG. 16 is a conceptual diagram of the optical element 140 along the longitudinal direction thereof in the optical apparatus 138A according to the variation of Embodiment 2.

As illustrated in FIG. 3 and FIG. 15, the scanning optical apparatus 32 according to the present embodiment may include the optical apparatus 138A according to the variation of Embodiment 2 instead of the optical apparatus 138 according to Embodiment 2. The optical apparatus 138A has the following configuration instead of including the presser 152 (see FIG. 14) of the optical apparatus 138. Note that, for convenience of description, members having the same functions as those described in Embodiment 2 are denoted by the same reference signs, and the description thereof is not repeated.

As illustrated in FIG. 15, the other one of the support pillars 102 (see FIG. 5) is provided with a second pressing member 168 that presses the optical element 140 to the side of the second seating surface member 148, and the second pressing member 168 is disposed on the other end side of the optical element 140 in the longitudinal direction thereof. The second pressing member 168 is formed of, for example, a plate spring made of metal such as stainless steel. At the second pressing member 168, a boss 168b that abuts on a portion of the second surface 140b of the optical element 140 on the one end side of the optical element 140 in the shorter direction thereof is formed by drawing.

The boss 168b of the second pressing member 168 is in point contact with the second surface 140b of the optical element 140. The boss 168b, which is the pressing location (contact location) of the second pressing member 168, is formed in a spherical shape. The boss 168b of the second pressing member 168 may be formed in a shape other than the spherical shape as long as the boss 168b is in point contact with the second surface 140b of the optical element 140.

The other one of the support pillars 102 is provided with a third pressing member 170 that presses the optical element 140 to the side of the third seating surface member 150, and the third pressing member 170 is disposed on the other end side of the optical element 140 in the longitudinal direction thereof. The third pressing member 170 is formed of, for example, a plate spring made of metal such as stainless steel. At the third pressing member 170, a boss 170b that abuts on a portion of the second surface 140b of the optical element 140 on the other end side of the optical element 140 in the shorter direction thereof is formed by drawing.

The boss 170b of the third pressing member 170 is in point contact with the second surface 140b of the optical element 140. The boss 170b, which is the pressing location (contact location) of the third pressing member 170, is formed in a spherical shape. The boss 170b of the third pressing member 170 may be formed in a shape other than the spherical shape as long as the boss 170b is in point contact with the second surface 140b of the optical element 140.

As illustrated in FIG. 15 and FIG. 16, the position of the boss 168b of the second pressing member 168 and the position of the boss 170b of the third pressing member 170 in the longitudinal direction of the optical element 140 may be different positions. The distance in the longitudinal direction of the optical element 140 between the support location of the second seating surface member 148 and the boss 168b of the second pressing member 168 may be identical to the distance in the longitudinal direction of the optical element 140 between the support location of the third seating surface member 150 and the boss 170b of the third pressing member 170. The bending moment due to a pressing force F₂ of the second pressing member 168 with the support location of the second seating surface members 148 as a fulcrum and the bending moment due to a pressing force F₃ of the third pressing member 170 with the support location of the third seating surface member 150 as a fulcrum may act in directions opposite to each other.

As described above, in the optical apparatus 138A, the one end side of the optical element 140 in the longitudinal direction thereof can be supported at one point (one location) by the support location of the first seating surface member 142. The other end side of the optical element 140 in the longitudinal direction thereof can be supported at two points (two locations) by the support location of the second seating surface member 148 and the support location of the third seating surface member 150.

As illustrated in FIG. 15, the second pressing member 168 and the third pressing member 170 correspond to a presser that presses the optical element 140 to the side of the second seating surface member 148 and the side of the third seating surface member 150. The pressing force (F₂+F₃) of the second pressing member 168 and the third pressing member 170 as the presser is set to be larger than the pressing force F₁ of the first pressing member 144 (see FIG. 13). The pressing force (F₂+F₃) of the second pressing member 168 and the third pressing member 170 may be set to be larger than twice the pressing force F₁ of the first pressing member 144. The pressing force F₂ of the second pressing member 168 may be set to be larger than the pressing force F₁ of the first pressing member 144. The pressing force F₃ of the third pressing member 170 may be set to be larger than the pressing force F₁ of the first pressing member 144.

In order to set the pressing force F₂ of the second pressing member 168 and the pressing force F₃ of the third pressing member 170 as described above, the shapes, thicknesses, materials, or the like of the second pressing member 168 and the third pressing member 170 may be different from the shape, thickness, material, or the like of the first pressing member 144. Each of the second pressing member 168 and the third pressing member 170 may be formed by stacking two plate springs that are the same as the plate spring forming the first pressing member 144.

According to the configuration of the optical apparatus 138A according to the variation of Embodiment 2, the pressing force (F₂+F₃) of the second pressing member 168 and the third pressing member 170 is set to be larger than the pressing force F₁ of the first pressing member 144 as described above. For this reason, the optical element 140 can be pressed to the side of the second seating surface member 148 and the side of the third seating surface member 150 with a strong force in comparison with a case where the pressing force (F₂+F₃) of the second pressing member 168 and the third pressing member 170 is the same as the pressing force F₁ of the first pressing member 144.

Accordingly, in a case where the one end side of the optical element 140 in the longitudinal direction thereof is supported at one point and the other end side of the optical element 140 in the longitudinal direction thereof is supported at two points, the optical apparatus 138A of the variation of Embodiment 2 makes it possible to suppress the floating of the optical element 140 from the second seating surface member 148 or the like. As a result, it is possible to reduce the rotational vibration of the optical element 140 around the axis along the longitudinal direction of the optical element 140 and enhance the image quality of the image forming apparatus 10. In particular, in a case where the optical element 140 is the fold mirror 92 (an example of a mirror), it is possible to reduce the influence of the rotational vibration of the optical element 140 on the traveling direction of the laser light B as the scanning light.

In addition, according to the configuration of the optical apparatus 138A according to the variation of Embodiment 2, the pressing force (F₂+F₃) of the second pressing member 168 and the third pressing member 170 is set to be larger than twice the pressing force F₁ of the first pressing member 144 as described above. For this reason, the optical element 140 can be pressed to the side of the second seating surface member 148 and the side of the third seating surface member 150 with a strong force in comparison with a case where the pressing force (F₂+F₃) of the second pressing member 168 and the third pressing member 170 is the same as the pressing force F₁ of the first pressing member 144.

Accordingly, even when there is a variation in the rotational moment of the optical element 140 due to the pressing force F₁ of the first pressing member 144, the optical apparatus 138A of the variation of Embodiment 2 makes it possible to further suppress the floating of the optical element 140 from the second seating surface member 148 or the like.

In addition, according to the configuration of the optical apparatus 138A according to the variation of Embodiment 2, each of the pressing force F₂ of the second pressing member 168 and the pressing force F₃ of the third pressing member 170 is set to be larger than the pressing force F₁ of the first pressing member 144 as described above. For this reason, the optical element 140 can be stably pressed to the side of the second seating surface member 148 and the side of the third seating surface member 150 with a strong force.

Accordingly, the optical apparatus 138A according to the variation of Embodiment 2 makes it possible to stably suppress the floating of the optical element 140 from the second seating surface member 148 and the third seating surface member 150.

In addition, according to the configuration of the optical apparatus 138A according to the variation of Embodiment 2, the distance between the support location of the second seating surface member 148 and the boss 168b of the second pressing member 168 is identical to the distance between the support location of the third seating surface member 150 and the boss 170b of the third pressing member 170. The bending moment due to the pressing force F₂ of the second pressing member 168 with the support location of the second seating surface member 148 as a fulcrum and the bending moment due to the pressing force F₃ of the third pressing member 170 with the support location of the third seating surface member 150 as a fulcrum act in directions opposite to each other. For this reason, the bending moment due to the pressing force F₂ of the second pressing member 168 and the bending moment due to the pressing force F₃ of the third pressing members 122 cancel each other.

Accordingly, the optical apparatus 138A according to the variation of Embodiment 2 makes it possible to suppress bending deformation of the optical element 140.

Although the present embodiment has been specifically described above, the present invention is not limited to the above-described specific embodiment. For example, any optical element other than the fold mirror 92 may be used as the optical element 100 of the optical apparatus 98, and any optical element other than the fold mirror 92 may be used as the optical element 140 of the optical apparatus 138 (138A). In addition, various variations and changes can be made to the specific examples described in the above embodiments within the scope of the spirit of the present invention described in the claims.

The present invention is useful as an optical apparatus, a scanning optical apparatus, and an image forming apparatus each capable of suppressing the floating of an optical element from a second supporter and a third supporter in a case where one end side of the optical element in the longitudinal direction thereof is supported at one point and the other end side of the optical element in the longitudinal direction thereof is supported at two points.

Although embodiments of the present invention have been described and illustrated in detail, the disclosed embodiments are made for purpose of illustration and example only and not limitation. The scope of the present invention should be interpreted by terms of the appended claims.

What is claimed is:

1. An optical apparatus, comprising:
an optical element that includes a first surface and a second surface on both sides of the optical element, respectively, in a thickness direction of the optical element;
a first supporter that is disposed on one end side of the optical element in a longitudinal direction of the optical element and supports the first surface or the second surface;
a first pressing member that presses the optical element to a side of the first supporter;
a second supporter that is disposed on another end side of the optical element in the longitudinal direction and supports a portion of the first surface on one end side of the optical element in a shorter direction of the optical element;
a third supporter that is disposed on the other end side of the optical element in the longitudinal direction and supports a portion of the first surface or the second surface on another end side of the optical element in the shorter direction; and
a presser that presses the optical element to a side of the second supporter and a side of the third supporter, wherein
a pressing force of the presser is set to be larger than a pressing force of the first pressing member.

2. The optical apparatus according to claim 1, wherein
the pressing force of the presser is set to be larger than twice the pressing force of the first pressing member.

3. The optical apparatus according to claim 1, wherein:
the third supporter is an adjustment member that supports a portion of the second surface on the other end side of the optical element in the shorter direction and adjusts a posture of the optical element by displacement of a support position, and
the presser includes:
a second pressing member that presses the optical element to the side of the second supporter; and
a third pressing member that presses the optical element to a side of the adjustment member.

4. The optical apparatus according to claim 3, wherein
each of a pressing force of the second pressing member and a pressing force of the third pressing member is set to be larger than the pressing force of the first pressing member.

5. The optical apparatus according to claim 3, wherein
a distance in the longitudinal direction between a support location of the second supporter and a pressing location of the second pressing member is identical to a distance in the longitudinal direction between a support location of the adjustment member and a pressing location of the third pressing member, and a bending moment due to a pressing force of the second pressing member with the support location of the second supporter as a fulcrum and a bending moment due to a pressing force of the third pressing member with the support location of the adjustment member as a fulcrum act in directions opposite to each other.

6. The optical apparatus according to claim 1, wherein:
the third supporter supports the portion of the first surface on the other end side of the optical element in the shorter direction, and
the presser presses the second surface between a location facing a support location of the second supporter and a location facing a support location of the third supporter.

7. The optical apparatus according to claim 1, wherein:
the third supporter supports the portion of the first surface on the other end side of the optical element in the shorter direction, and
the presser includes:
a second pressing member that presses the optical element to the side of the second supporter; and
a third pressing member that presses the optical element to the side of the third supporter.

8. The optical apparatus according to claim 7, wherein
each of a pressing force of the second pressing member and a pressing force of the third pressing member is set to be larger than the pressing force of the first pressing member.

9. The optical apparatus according to claim 7, wherein
a distance in the longitudinal direction between a support location of the second supporter and a pressing location of the second pressing member is identical to a distance in the longitudinal direction between a support location of the third supporter and a pressing location of the third pressing member, and a bending moment due to a pressing force of the second pressing member with the support location of the second supporter as a fulcrum and a bending moment due to a pressing force of the third pressing member with the support location of the third supporter as a fulcrum act in directions opposite to each other.

10. The optical apparatus according to claim 1, wherein
the first supporter supports the first surface.

11. The optical apparatus according to claim 1, further comprising:
a side-surface supporter that abuts on a side surface of the optical element on the one end side of the optical element in the shorter direction; and
a side-surface pressing member that presses the optical element to a side of the side-surface supporter.

12. The optical apparatus according to claim 11, wherein
each of the side-surface supporter and the side-surface pressing member is disposed on the one end side of the optical element in the longitudinal direction.

13. The optical apparatus according to claim 1, further comprising a falling-off regulator that is in a non-pressing state with respect to the optical element and regulates falling off of the optical element from the second supporter and the third supporter by regulating movement of the optical element in an in-plane direction of the optical element.

14. The optical apparatus according to claim 1, further comprising a reinforcement member attached to a central portion of the optical element in the longitudinal direction.

15. The optical apparatus according to claim 1, wherein
each of a pressing location of the first pressing member and a pressing location of the presser is in point contact with the optical element.

16. The optical apparatus according to claim 15, wherein
each of the pressing location of the first pressing member and the pressing location of the presser is formed in a spherical shape.

17. The optical apparatus according to claim 1, wherein
each of a support location of the first supporter, a support location of the second supporter, and a support location of the third supporter is in point contact with the optical element.

18. The optical apparatus according to claim 17, wherein
each of the support location of the first supporter, the support location of the second supporter, and the support location of the third supporter is formed in a spherical shape.

19. A scanning optical apparatus, comprising:
a light source that emits scanning light;
a polarizer that polarizes the scanning light emitted from the light source; and
the optical apparatus according to claim 1, the optical apparatus being disposed on an optical path of the scanning light polarized by the polarizer.

20. An image forming apparatus, comprising:
an image carrier that forms an image; and
the scanning optical apparatus according to claim 19, the scanning optical apparatus forming an electrostatic latent image on the image carrier by exposure-scanning the image carrier.
